(19) United States
(12) Patent Application Publication
(10) Pub. No.: US 2008/0038620 A1
(43) Pub. Date: Feb. 14, 2008

(54) Method for Producing a Fuel Cell Stack

(75) Inventor: Michael Stelter, Chemnitz (DE)

Correspondence Address: Roberts Mlotkowski & Hobbes, 8270 Greensboro Drive, Suite 850, McLean, VA, 22102, US

(73) Assignee: Webasto AG, Stockdorf (DE)

(21) Appl. No.: 10/565,806

(22) PCT Filed: Jul. 23, 2004
(86) PCT No.: PCT/DE04/01639

§ 371 Date: Jan. 25, 2006

(30) Foreign Application Priority Data
Jul. 25, 2003 (DE) 103 34 131.5

(51) Int. Cl. H01M 8/24

(52) U.S. Cl. 429/35; 29/623.2

(57) ABSTRACT

A method for producing a fuel cell stack having the following steps: a) providing a first duplicating unit (10) with a first sealing surface (10a) and at least one second duplicating unit (16) with a second sealing surface (16a) and b) forming at least one sealing section (42) between the first sealing surface (10a) and the second sealing surface (16a). The step b) includes the steps of: b1) arranging a template (22) between the first sealing surface (10a) and the second sealing surface (16a), whereby the template (22) has at least one edge area (32) which is arranged adjacent to the sealing section to be formed (42), and b2) introducing a sealing compound (40) into an area which is defined by the first sealing surface (10a), the second sealing surface (16a) and the edge area (32) of the template (22).

### BACKGROUND OF THE INVENTION

1. Field of the Invention

The invention relates to a process for producing a fuel cell or a fuel cell stack with the following steps: a) Providing a first duplicating unit with a first sealing surface, and at least a second duplicating unit with a second sealing surface; and b) forming at least one seal section between the first sealing surface and the second sealing surface.

2. Description of Related Art

For example, SOFC fuel cell stacks (SOFC=“solid oxide fuel cell”) comprise a plurality of so-called duplicating units between which there are seals which, in many cases, establish the spacing of the duplicating units, and for example, seal openings which extend in the stack direction of the fuel cell stack. Furthermore, there are generally an upper and a lower end plate and current collector plates. Fuel cell stacks are known in which the individual layers are rigidly cemented (for example, by a glass paste), as are fuel cell stacks which have detachable, compressible seals or compound seals.

One problem in the production of fuel cells or fuel cell stacks is that the individual seals are extremely complex to produce, and in many case, for example, a large amount of waste being formed in punching. Furthermore, at present, only very time consuming series fabrication is possible. For this purpose, doctoring a glass paste which forms the sealing compound in series on each individual duplicating unit or placing it in beads using a dispenser is known. Series fabrication is, furthermore, susceptible to faults. For example, the failure rate of a fuel cell stack is:

Failure rate=1−(1−p)ⁿ,

n being the number of seals and p being the failure probability of an individual seal.

### SUMMARY OF THE INVENTION

The object of the invention is to develop a generic process such that the fault susceptibility is reduced and parallel fabrication becomes possible.

This object is achieved by arranging a template between a first sealing surface and a second sealing surface, the template having at least one edge area which is located adjacent to the seal section which is to be formed; and placing a sealing compound in the area which is bordered by the first sealing surface, the second sealing surface and the edge area of the template. This approach enables rapid and controlled assembly in which several seals can be aligned at the same time. Furthermore, the material loss, compared to known processes, is low, as is the fault susceptibility. The dimensions of at least one seal section which is to be formed can be easily influenced by the choice of the dimensions of the template.

The advantages of the process of the invention become especially apparent when it is provided that there is a plurality of duplicating units on top of one another for stacking a fuel cell stack, at least one template at a time being provided between a respective two adjacent duplicating units. In this case, a plurality of seal sections provided between the individual duplicating units can be produced in parallel.

Furthermore, it is preferred that the template be formed at least in part from an organic fiber material, a carbon fiber material or a corresponding composite material. The respective material can be, for example, a felt, nonwoven, knit or woven fabric.

Furthermore, it can be advantageously provided that the template be completely or partially removed during and/or after formation of at least one seal section and/or changed partially or entirely in its material properties. For example, the template can be made of a non-temperature resistant (for example, for temperatures exceeding 800° C.), combustible, flat material. In this case, the template can be completely removed by burning after formation of at least one seal section. Alternatively, the template can be made of a material which, instead of being flammable, has the property of losing its mechanical stability under the action of temperature, i.e., collapsing under the action of a force. Furthermore, the material (or its decomposition products) can be electrically insulating. For this purpose, the material can be formed, for example, by an organic or ceramic fiber composite or foam material in which, under the action of temperature, at least one structure-forming component vaporizes, bums or melts. As already mentioned, a composite material which represents a combination of the aforementioned materials is also possible.

In preferred embodiments of the process of the invention, it is provided that the sealing compound contains dispersed components for a glass solder.

It is furthermore preferred that the sealing compound is subjected, at least in part, to a curing and/or gelling process to form at least one seal section. The sealing compound preferably contains a curing agent component for curing or gelling. The curing agent component of the sealing compound can be advantageously added just briefly before injection or placement in the corresponding area. The curing or gelling agent can be activated, for example, by air feed, temperature or a chemical activator which has been applied to the template and/or at least one sealing surface.

Without being limited hereto, it is preferred that at least one seal section is formed adjacent to the first recess in the first duplicating unit. The recess can be intended especially to form a gas channel which extends through the fuel cell stack.

It can be similarly provided that at least one seal section is formed adjacent to the first recess in the second duplicating unit. Without being limited hereto, the process as claimed in the invention can be especially advantageously used when a first recess in the first duplicating unit is aligned with the second recess in the second duplicating unit in the stacking direction.

Especially in this connection, it is furthermore preferred that the template has a first recess with dimensions which are larger than the dimensions of the first recess in the first duplicating unit and/or larger than the dimensions of the first recess in the second duplicating unit. In this case, the excess of the first recess in the template establishes the width of the seal section to be formed while the height of the template establishes the height of the seal section which is to be formed.

In especially preferred embodiments of the process in accordance with the invention, it is provided that the sealing compound according to is applied at least partially by way of the first recess in the first duplicating unit and/or by way of the first recess in the second duplicating unit and/or by way of the first recess in the template. To apply the sealing compound, preferably, a feed means which can comprise, for example, a hose or a tube is used. Preferably, there is a flange or other coupling means with which the supply means can be connected to one of the first recesses with sealing.

In the above explained connection it is also considered to be advantageous if it is provided that when the sealing compound is applied, a mandrel extends at least partially through the first recess in the first duplicating unit and/or the first recess in the second duplicating unit and/or the first recess in the template. The mandrel, preferably, has only slightly smaller outside dimensions than the inside dimensions of the first openings. The viscosity of the sealing compound is preferably chosen such that only little or no sealing compound runs into the opening which is then cleared when the mandrel is removed.

In certain embodiments of the process of the invention, it is provided that the first duplicating unit has a second recess and/or the second duplicating unit has a second recess and/or the template has a second recess. Here, it is preferred that the existing second recesses are aligned with one another in the stack direction.

In this connection, it is preferred that the first recess of the template is connected to the second recess of the template by way of the first channel. In this case, the second recesses which are aligned with one another can form a filling channel for the sealing compound, the sealing compound traveling by way of the first channel from the fill opening to the first recesses in which preferably the aforementioned mandrel is located. Here, it is considered to be advantageous if the fill channel has a cross sectional area which is relatively large compared to the cross-sectional area of the seal section which is to be formed. In this way, the hydrodynamic pressure loss in the fill channel is much smaller than in the sealing channel when a fluid (or the sealing compound) flows through the two channels.

It can be furthermore provided that the application of the sealing mass takes place at least in part by way of the second recess in the first duplicating unit and/or by way of the second recess in the second duplicating unit and/or by way of the second recess in the template.

Furthermore, it can be provided that the sealing compound present in the second recess in the first duplicating unit and/or in the second recess in the second duplicating unit and/or in the second recess in the template is at least partially removed again, especially using a second mandrel. Alternatively, the sealing compound can remain in the channel formed by the second recesses and can cure there in order to increase the stability of the overall structure.

For all embodiments of the process in accordance with the invention, it is preferred that the first duplicating unit and the second duplicating unit are at least temporarily compressed in the course of placing the sealing compound in the area which is bordered by the first sealing surface, the second sealing surface and the edge area of the template. When the sealing compound is being added, this prevents the duplicating units from being moved apart by the sealing compound. In later process steps, the compression can contribute to causing a collapse of the template(s).

The invention is also intended to encompass any fuel cell stack which is produced with the process of the invention. This applies especially to a fuel cell stack in which at least two seal sections which are at least essentially aligned with one another in the stack direction of the fuel cell stack are connected by sealing compound. The seal sections which are connected by the sealing compound and which are located on top of one another between several duplicating units constitute a distinct indicator that the process in accordance with the invention has been used.

The finding that, by using templates located between two duplicating units at a time, it is possible to form a plurality of seals which are to be provided on top of one another at the same time is critical to this invention.

Preferred embodiments of the invention are explained by way of example below with reference to the accompanying drawings.

### BRIEF DESCRIPTION OF THE DRAWINGS

FIG. 1 are top views and cross-sectional views taken along line I-I of the top views of a first and a second duplicating unit and of a template;

FIG. 2 shows the template from FIG. 1 located on the first duplicating unit from FIG. 1 in a top view and a cross-sectional view taken along line I-I of the top views;

FIG. 3 shows the second duplicating unit from FIG. 1 located on the arrangement from FIG. 2 in a top view and a cross-sectional view taken along line I-I of the top view;

FIG. 4 is a cross-sectional view taken along line I-I of FIG. 3 and which illustrates application of the sealing compound;

FIG. 5 is a sectional view of the arrangement shown in FIG. 4 taken along line II-II thereof; and

FIG. 6 shows is a view corresponding to FIG. 5 showing a completed seal section.

### DETAILED DESCRIPTION OF THE INVENTION

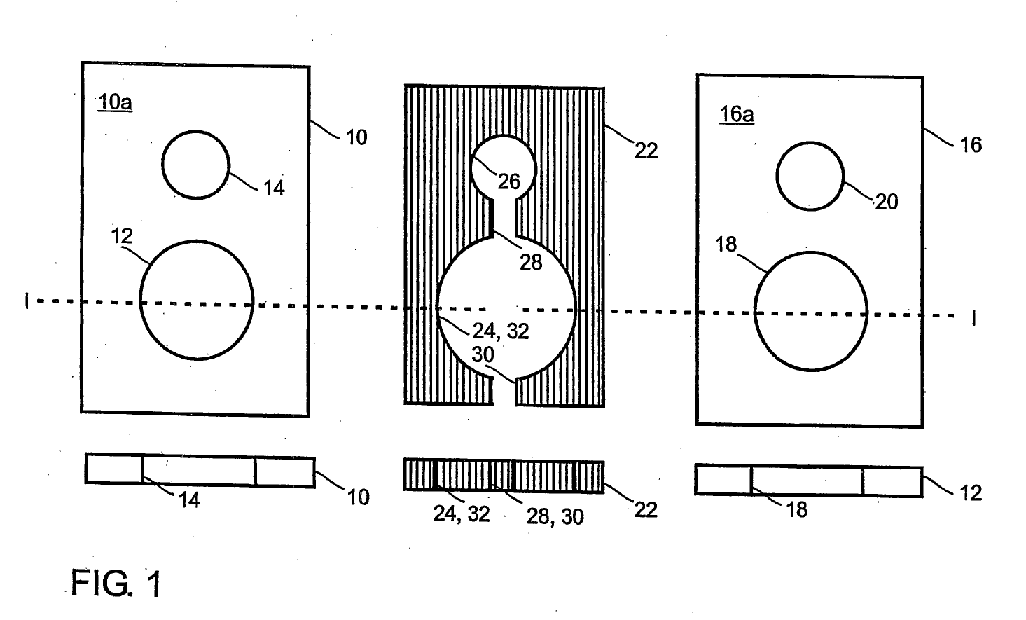

FIG. 1 shows a first duplicating unit 10, a second duplicating unit 16 and a template 22. As shown in FIG. 1, the first duplicating unit 10 has a first sealing surface 10a and a first opening 12 and a second opening 14. The second duplicating unit 16 has a second sealing surface 16a and a first recess 18 and a second recess 20.

In this case, the structure of the first duplicating unit 10 and the structure of the second duplicating unit 16 are identical, although the invention is not limited to these embodiments since applications are also possible in which seals arranged differently are formed between different duplicating units.

A template 22 is shown between the first duplicating unit 10 and the second duplicating unit 16. The template 22 has a first recess 24 and a second recess 26. The periphery of the first recess 24 in the template 22, in this case, defines an edge area 32 which is intended to be located adjacent to the seal section which is to be formed. The first recess 24 and the second recess 26 of the template 22 are connected to one another by a first channel 28. Furthermore, the outside periphery of the template 22 is connected by way of a second channel 30 to the first recess 24.

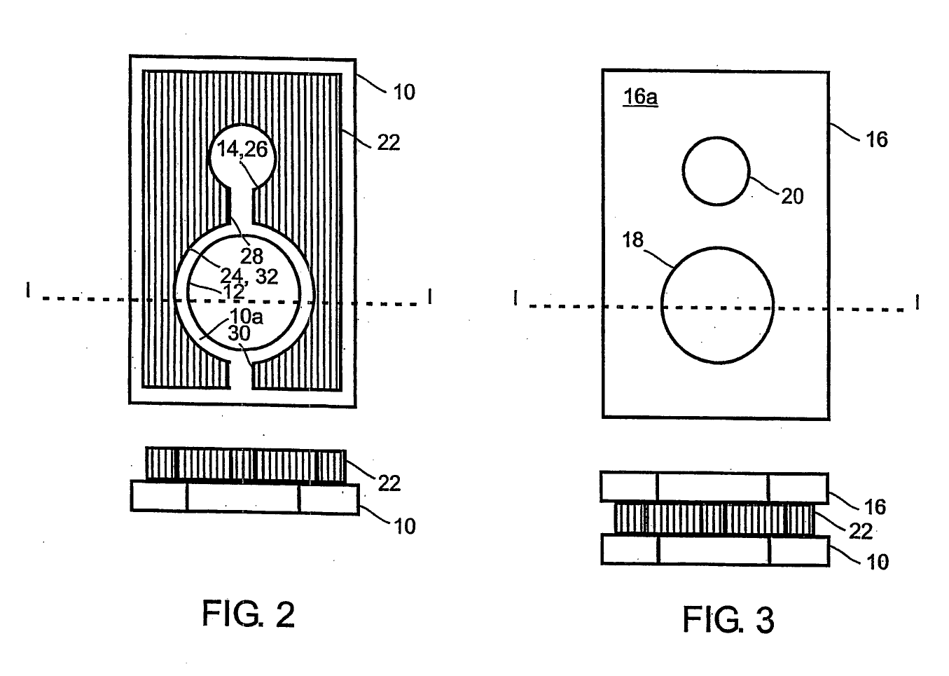

FIG. 2 shows the template 22 from FIG. 1 located on the first duplicating unit 10 from FIG. 1 and from which it can be seen that the dimensions of the first recess 24 in the template 22 are chosen to be somewhat larger that the dimensions of the first recess 12 in the first duplicating unit 10. The excess of the first recess 24 in the template 22 defines the width of the seal section which is to be formed and which is to be made in this case essentially in the shape of a circular ring around of the first recess 12 of the first duplicating unit 10.

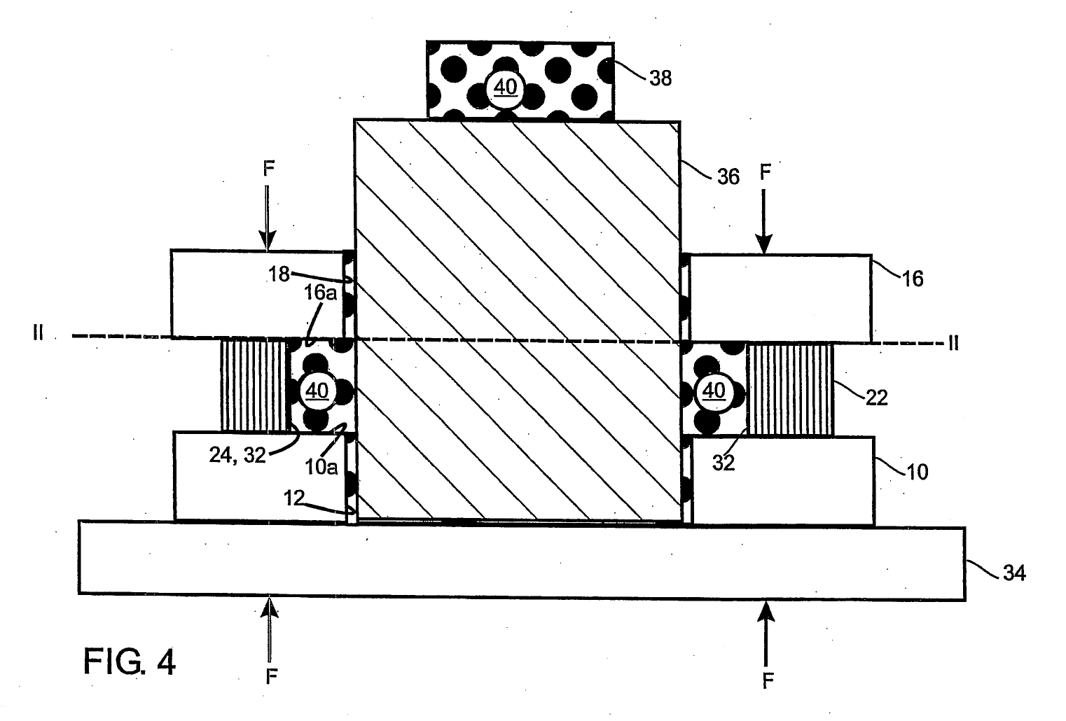

FIG. 3 shows the second duplicating unit 16 from FIG. 1 located on the arrangement from FIG. 2 with the template 22 located between the first duplicating unit 10 and the second duplicating unit 16 such that the first recesses 12, 18, 24 and the second recesses 14, 20, 26 are aligned with one another in the stack direction, at least in essence.

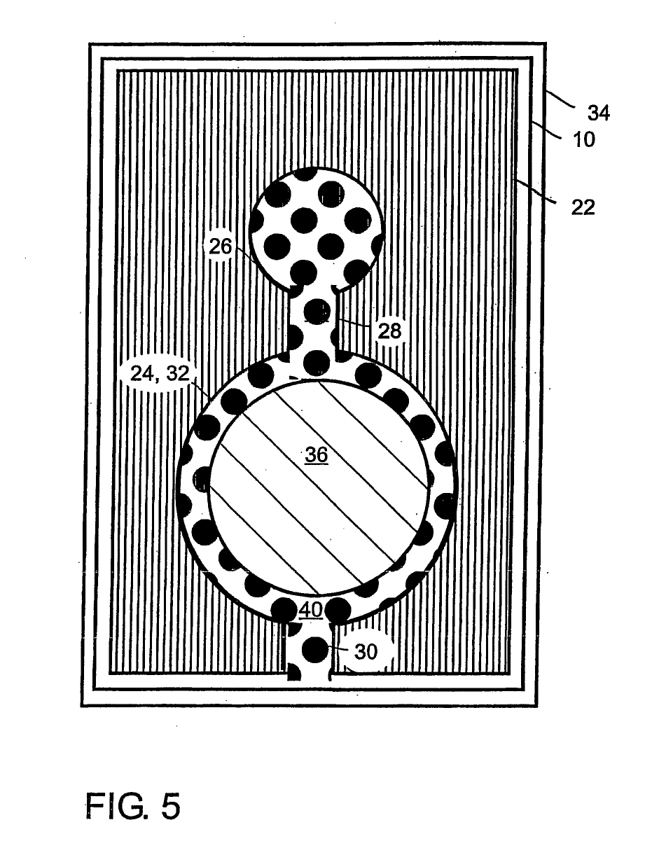

FIGS. 4 & 5 illustrate the application of the sealing compound 40. For the sake of clarity, FIG. 4 shows only two duplicating units 10, 16 with a template 22 located in between. But, one skilled in the art easily recognizes that the process of the invention entails advantages especially when a fuel cell stack is stacked with a plurality of duplicating units and templates located between them.

Recesses aligned with one another in the individual duplicating units can form one or more channels which extend essentially parallel to the stack axis through the fuel cell stack, especially gas supply channels. In this case, the seal gaps which form between the individual duplicating units must be sealed to prevent escape of gas to the outside when the fuel cell is in operation. The seals which are made between the duplicating units in accordance with the invention should generally be made electrically insulating so that the duplicating units are not electrically short-circuited. Furthermore, it is necessary in many cases for the seals to be fluid-tight even at high temperatures, and preferably, also under mechanical vibrations, for which reason especially a glass solder is considered as the seal material.

Furthermore, FIG. 4 shows only one lower end plate 34. However, it will be clear to one skilled in the art that the fuel cell stack generally also has an upper end plate which is not own. In the illustrated case, the end plate 34 does not have an opening which is aligned to the first openings 12, 18, 24 and is therefore used as a permanent blocking element which also remains a component of the arrangement even after the sealing compound 40 is applied.

Alternatively, the use of at least one temporary blocking element which is removed after the sealing compound is applied is conceivable. Similarly, both permanent and also temporary clamping devices for mechanical bracing of the fuel cell stack are possible.

Although, as mentioned, with the process of the invention, preferably a plurality of seal sections are produced at the same time, the production of only one seal section 42 which seals the first recesses 12, 18 in the duplicating units 10, 16 is explained below.

To produce the seal section, the first duplicating unit 10, the template 22 and the second duplicating unit 16 are stacked on an end plate 34 such that the respective recesses 12, 18, 24 or 14, 20, 26 are aligned with one another. The second recesses 14, 20, 26 form a supply or fill opening 40 for the sealing compound. A supply means 38 which is shown only schematically in FIG. 4 is connected to this fill opening with sealing so that the sealing compound 40 which has been applied to the second recesses 14, 20, 26 travels by way of the channel 28 of the template 22 into the first recesses 12, 18 and 24. The sealing compound is preferably applied under high pressure. According to the hydrodynamic pressure loss, generally, the fill channel formed by the two recesses 14, 20, 26 is completely filled first. Afterwards, the sealing compound 40 is distributed in the sealing channels. The displaced air can leave the channels, for example, through the second channel 30 of the templates 22 or through the template 22 if it has a porous structure.

During application of the sealing compound 40, the entire arrangement is compressed by an externally applied, preferably controlled force F. The second channel 30 of the template 22 makes it possible for a sealing compound 40 which may have been applied in excess to escape again. In the first recesses 12, 18, and 24 which are aligned with one another there is a mandrel 36 with outside dimensions which are somewhat smaller than the inside dimensions of the first recesses 12, 18. The mandrel 36 is used especially to suitably establish the cross-sectional ratio of the fill opening which has been formed by the second recesses and the seal which is to be formed in order to achieve hydrodynamically favorable properties.

At the end of the filling process, all of the sealing channels are filled with the sealing compound 40. Further, pressing-in of the sealing compound 40 leads to the sealing compound 40 penetrating into the second channel 30 or into the pore structure of the template 22. This rapidly increases the pressure in the seal channel, and thus, in the fill channel. This pressure rise can be advantageously detected in order to end the filling process.

Basically, it holds that the application of the sealing compound 40 can be supported by a negative pressure (vacuum) which prevails against the outer sides of the template 22 relative to the inner sides. Since the pressure is continuously equalized by the second channel 30 and the porous configuration of the template 22, the negative pressure must be maintained if necessary by continuous after-pumping in the device. The negative pressure provides for the sealing compound being sucked more rapidly into the recess of the template 22 and for preventing the formation of air inclusions/air bubbles.

As soon as the sealing compound 40 is fixed in its gap, the mandrel 36 can be removed without a significant amount of the sealing compound 40 traveling into the first recesses 12, 18. But, alternatively, it can likewise be provided that the mandrel 36 is formed, for example, by a tie rod which is left in the fuel cell stack in order to maintain bracing of the finished product. After the supply means 38 has been decoupled, the entire arrangement is placed, for example, in a furnace, optionally while maintaining compression by the force F, in order to cure the sealing compound 40.

In this case, due to the temperature rise, the sealing compound 40 first releases its solvents or diluents and possible binders. The vapors can escape through the second channel 30 of the template 22 or through the template 22 if it is made porous. As time progresses, after all the binders and solvents have escaped from the sealing compound, the sealing compound is present, for example, as the dry raw substance of a glass solder, i.e., as a porous body with the shape of the seal section which is to be formed. Such a porous base body constitutes a mechanical resistance when the fuel cell stack is compressed (i.e., when the sealing surfaces 10a, 16a are compressed). Therefore, the pore body will possibly collapse in a controlled manner as the compression increases, and in doing so, decrease in its height (reduction of pore volume). As time passes, the components of the seal section or of the sealing element begin to sinter and melt according to the composition of the glass solder. In doing so, a transition takes place from the solid to a highly viscous liquid consistency of the sealing element. As the temperature increases further, the glass solder melts completely and wets the surfaces of successive duplicating units 10, 16, which surfaces are to be sealed relative to one another. The high quality non-Newtonian flow behavior of such a glass melt and the capillary action within the sealing gap prevent the glass solder from being pressed completely out of the sealing gap within a defined time interval, even as the sealing surfaces are further compressed. The continued compression, and thus, the reduction of the height of the sealing element are advantageous for equalizing the shrinkage of the seal section which can occur by the release of binders and solvents as well as enclosed air and gas bubbles.

Further compression of the fuel cell stack in the course of the joining process can take place, for example, according to the two following versions.

In the case of a combustible template 22, it bums preferably without residues as the temperature continues to rise. Compression of the fuel cell stack caused by temporary or permanent bracing of the fuel cell stack during the combustion process causes the template 22 to collapse during combustion. The successive duplicating units are prevented from touching each other by the limiting and/or metering of the compression force F. Touching would result in that the sealing compound 40 under certain circumstances would be pressed completely out of the sealing gap and the duplicating units 10, 16, and moreover, would electrically short circuit. By limiting the force F, the sealing compound 40 remains essentially in its original form in the plane which was defined by the sealing gap so that a surface seal (seal section 42) is formed around the recesses 12, 18 which are to be sealed. The height of the seal section 42 or of the sealing element is (somewhat) smaller than the height of the original air gap (negative form) since the sealing compound 40, as mentioned, releases binder and solvent during the melting process and thus shrinks. It is therefore advantageous to track the bracing of the fuel cell stack during combustion.

In another version, the template 22 is not burned (without residue), but selective collapse of the template 22 is caused by the bracing of the fuel cell stack, supported by the loss (thermal decomposition) of at least one structure-forming component. In this case, the electrically insulating action of the template 22 or of the corresponding decomposition products can be advantageously used to reliably prevent short circuits between successive duplicating units 10, 16.

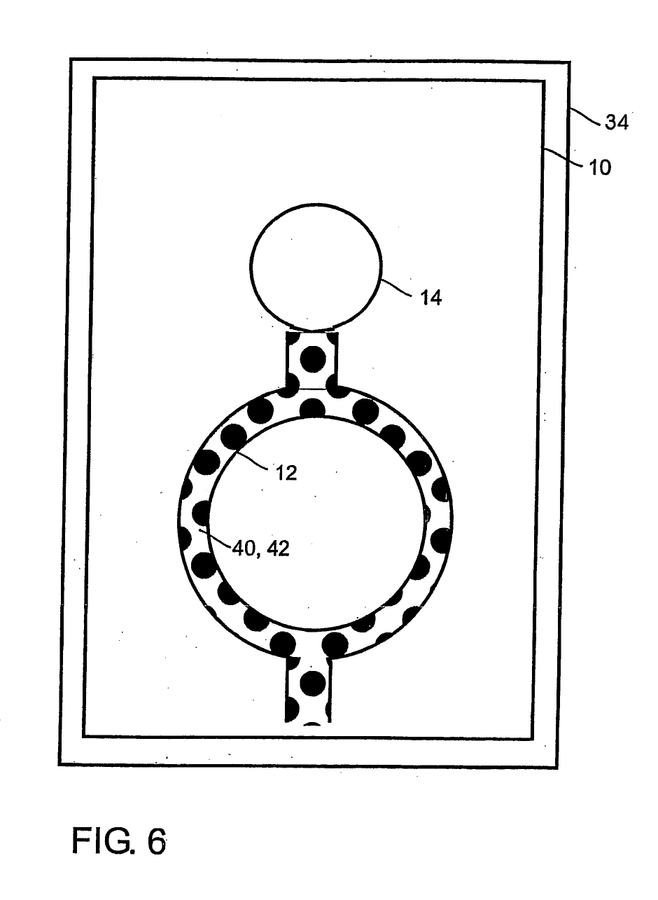

FIG. 6 shows a top view of a completed seal section corresponding to FIG. 5. FIG. 6 shows that the seal section 42 which has been produced in accordance with the invention extends in the shape of a circular ring around the first recess 12 in the first duplicating unit 10 so that the seal section 42 forms a channel which connects the first recesses 12, 18. The sealing compound present in the second recess 14 was removed as shown in FIG. 6 before curing of the sealing compound 40 by means of another mandrel (not shown). But, embodiments are likewise conceivable in which the sealing compound 40 remains in the second recesses in order to increase the stability of the overall structure.

Although the above explained embodiments of the invention can be considered especially advantageous, a plurality of modifications is possible. For example, embodiments are conceivable in which there are no second recesses so that the sealing compound is added directly to the first recesses. The mandrel 36 can be abandoned if necessary. It is likewise conceivable for the mandrel 36 to be inserted only after the sealing compound is applied in order to remove the sealing compound from the first recesses. Alternatively, the sealing compound can remain in the first recesses.

Furthermore, it can be provided that the sealing compound 40 is filtered by a porous configuration of the template 22. In this case, the second channel 30 of the template 22 is preferably omitted. The sealing compound 40 is pressed from the sealing gap through the template 22 by the internal pressure. In doing so, solid particles (glass solder) are retained while the diluent of the sealing compound 40 (water) is pressed to the outside as a filtrate and runs off. In this way, in spite of highly diluted sealing compound 40 which can therefore flow better, a very compact blank for the seal section which is to be made can be formed (filter cake).

The rapid and controlled outflow of the diluent through the porous structure of the template can be improved by a surface modification of the fiber or pore structure by increasing the wetting of the fiber/pore structure by the solvent. In the case of water for example, a hydrophilic surface layer or impregnation with a hydrophilic component can improve the discharge of water to the outside.

The features of the invention disclosed in the description above, in the drawings and in the claims can be significant to the implementation of the invention both individually and also in any combination.

1. Process for producing a fuel cell or a fuel cell stack with the following steps:
a) providing a first duplicating unit (10) with a first sealing surface (10a), and at least a second duplicating unit (16) with a second sealing surface (16a); and
b) forming at least one seal section (42) between the first sealing surface (10a) and the second sealing surface (16a);
step b) comprises:
b1) arranging a template (22) between the first sealing surface (10a) and the second sealing surface (16a), the template (22) having at least one edge area (32) which is located adjacent to where the at least one seal section (42) is to be formed; and
b2) placing a sealing compound (40) in an area which is bordered by the first sealing surface (10a), the second sealing surface (16a) and the at least one edge area (32) of the template (22).

2. Process as claimed in claim 1, wherein a plurality of duplicating units (10, 16) are provided on top of one another for stacking a fuel cell stack, and providing at least one template between each two adjacent duplicating units.

3. Process as claimed in claim 1, wherein the template (22) is formed at least in part from an organic fiber material, a carbon fiber material or a corresponding composite material.

4. Process as claimed in according to claim 1, wherein the template (22) is at least partially removed at least one of during and after formation of at least one seal section.

5. Process as claimed in claim 1, wherein the sealing compound contains dispersed components for a glass solder.

6. Process as claimed in claim 1, wherein the sealing compound (40) is subjected at least in part to at least one of a curing and gelling process to form at least one seal section (42).

7. Process as claimed in claim 1, wherein at least one seal section (42) is formed adjacent to the first recess (12) in the first duplicating unit (10).

8. Process as claimed in claim 1, wherein at least one seal section (42) is formed adjacent to the first recess (18) in the second duplicating unit (16).

9. Process as claimed in claim 1, wherein at least one seal section is formed adjacent to the first recess in at least one of the first and second duplicating units: and wherein the template (22) has a first recess (24) with dimensions which are larger than the dimensions of the first recess the respective duplicating unit (16).

10. Process as claimed in claim 9, wherein that the sealing compound is applied in step b2 at least partially by way of the first recess (12) in at least one of the first duplicating unit, the second duplicating unit (16) and the template (22).

11. Process as claimed in claim 10, wherein, when the sealing compound is applied according to step b2, a mandrel (36) extends at least partially through the first recess (12) in at least one of the first duplicating unit, the second duplicating unit (16) and the template (22).

12. Process as claimed in claim 1, wherein at least one of the first duplicating unit, the second duplicating unit, and/or and the template (22) has a second recess (26).

13. Process as claimed in claim 1, wherein the template has a second rescess; and wherein the first recess (24) of the template (22) is connected to the second recess (26) of the template (22) by way of the first channel (28).

14. Process as claimed in claim 12, wherein application of the sealing compound according to step b2 takes place at least in part by way of the second recess (14) in said at least one of the first duplicating unit, the second duplicating unit, and the template (22).

15. Process as claimed in claim 14, wherein, after completion of step 2b, the sealing compound (40) present in the second recess (14) in said at least one of the first duplicating unit, the second duplicating unit, and the template (22) is at least partially removed.

16. Process as claimed in claim 1, wherein the first duplicating unit (10) and the second duplicating unit (16) are at least temporarily compressed in the course of step b).

17. Fuel cell stack produced with the process as claimed in claim 1.

18. Fuel cell stack as claimed in claim 17, wherein at least two seal sections which are essentially aligned with one another in a direction of stacking of the fuel cell stack are connected by the sealing compound.

19. Process as claimed in claim 1, wherein the template is at least partially changed in its material properties at least one of during and after formation of at least one seal section.

20. Process as claimed in claim 15, wherein, after completion of step 2b, the sealing compound present in the second recess in said at least one of the first duplicating unit, the second duplicating unit, and the template is at least partially removed using a mandrel.
